(19) United States
(12) Patent Application Publication
(10) Pub. No.: US 2007/0254974 A1
(43) Pub. Date: Nov. 1, 2007

(54) Production of polyurethane wound dressing foams

(76) Inventors: Michael Mager, Leverkusen (DE); Thorsten Rische, Unna (DE); Sebastian Dorr, Dusseldorf (DE); Thomas Feller, Solingen (DE); Michael Heckes, Krefeld (DE); Melita Dietze, Erkrath (DE); Burkhard Fugmann, Ratingen (DE)

Correspondence Address: BAYER MATERIAL SCIENCE LLC, 100 BAYER ROAD, PITTSBURGH, PA, 15205, US

(21) Appl. No.: 11/732,574

(22) Filed: Apr. 4, 2007

(30) Foreign Application Priority Data
Apr. 8, 2006 (DE) 102006 016639.6

(51) Int. Cl. C08G 18/00

(52) U.S. Cl. 521/172

(57) ABSTRACT

The invention relates to a process for producing polyurethane wound dressing foams comprising frothing and drying polyurethane foam compositions which comprise anionically hydrophilicized aqueous polyurethane dispersions.

### CROSS-REFERENCE TO RELATED PATENT APPLICATION

The present patent application claims the right of priority under 35 U.S.C. §119 (a)-(d) of German Patent Application No. 10 2006 016 639.6, filed on Apr. 8, 2006.

### BACKGROUND OF THE INVENTION

The invention relates to a process for producing polyurethane wound dressing foams. In particular, this process comprises frothing and drying a polyurethane foam composition without chemical crosslinking, in which the foam comprises a polyurethane dispersion having a specific composition.

In the field of wound management, the use of polyurethane foams is well known. The polyurethane foams suitable for this purpose are generally hydrophilic in order that good absorption of wound fluid may be ensured. Hydrophilic polyurethane foams are typically obtained by the reaction of mixtures of diisocyanates and polyols, or NCO-functional polyurethane prepolymers, with water in the presence of certain catalysts and also (foam) additives. Aromatic diisocyanates are typically used, since they exhibit the best foaming properties. Numerous forms of these processes for producing polyurethane foams are known and described in, for example, U.S. Pat. No. 3,978,266, U.S. Pat. No. 3,975,567 and EP 0 059 048. The aforementioned processes, however, have the disadvantage that they require the use of reactive mixtures which contain diisocyanates or corresponding NCO-functional prepolymers, the handling of which is technically inconvenient and costly due to the necessary appropriate protective measures associated with such diisocyanates or NCO-functional prepolymers of these diisocyanates.

It is also known to produce foams from polyurethane dispersions by incorporating air in the presence of suitable (foam) additives by vigorous stirring. The so-called mechanical polyurethane foams are obtained after drying and curing. In connection with wound contact materials, such foams are described in EP 0 235 949 and EP 0 246 723, with the foam either having a self-adherent polymer added to it, or the foam being applied to a film of a self-adherent polymer. The use of foams as such, i.e. without self-adherent polymers, is not described. In addition, the examples in EP 0 235 949 and EP 0 246 723 require that polyaziridines as crosslinkers. Polyaziridines are no longer acceptable, however, because of their toxicity. Moreover, crosslinking requires the use of high baking temperatures, with these temperatures reported to be in the range from 100° C. to 170° C. U.S. Pat. No. 4,655,210 describes the use of the aforementioned mechanical foams for wound dressings which have a specific design made up of a backing, a foam and a skin contact layer.

The polyurethane dispersions described in EP-A 0 235 949, EP-A 0 246 723 and U.S. Pat. No. 4,655,210 are anionically hydrophilicized through the incorporation of certain carboxylic acids, such as dimethylol carboxylic acids, and neutralization of the carboxylic acids with tertiary amines such as, for example, triethylamine. However, the ammonium carboxylates formed in this manner are decomposable, and particularly at higher temperatures, which sets the amines free again. This is an immense disadvantage relative to the processing of such products and particularly, in the processing of such products for skin contact. Furthermore, these polyurethane dispersions were produced using the dimethylol carboxylic acids in dissolved form such as, for example, in dimethylformamide or N-methylpyrrolidone, and as a result of this, the final products have a high VOC content. For example, in the case of Witcobond® 290 H, the VOC content is 10.8 g liter (without water).

EP 0 760 743 describes mechanical foams which are prepared from latex dispersions. These mechanical foams do not consist of polyurethanes and have worse mechanical properties than the mechanical polyurethane foams.

An object of the present invention is to provide novel polyurethane wound dressing foams which are based on polyurethane foam forming compositions and which are prepared in a very simple manner and without the use of building block components and/or additives that are not generally recognized as safe from a toxicological and/or physiological perspective. It is a further desired that these wound contact materials have good mechanical properties, including a high uptake capacity for physiological saline and also a high water vapor transmission rate.

### SUMMARY OF THE INVENTION

It has now been found that such polyurethane-based wound dressing foams are obtainable wherein compositions which comprise specific aqueous polyurethane dispersions are frothed and then physically dried.

The present invention accordingly provides a process for producing polyurethane wound dressing foams which comprises frothing and drying polyurethane foam forming compositions without chemical crosslinking, in which the polyurethane foam forming composition comprises (I) at least one anionically hydrophilicized, aqueous polyurethane dispersion.

As used herein, the term crosslinking is to be understood as meaning the formation of covalent bonds.

For purposes of the present invention, polyurethane foam wound contact materials are porous materials, preferably having at least some open-cell content, which are made of polyurethanes. These materials protect wounds against germs and environmental influences like a sterile covering, and they have a fast and high absorbence of physiological saline (i.e. more precisely wound fluid), a suitable permeability for moisture to ensure a suitable wound climate, and sufficient mechanical strength.

In a preferred embodiment of the invention, it is preferred that these dispersions are anionically hydrophilicized by means of sulfonate groups. More preferably, only sulfonate groups are responsible for the anionic hydrophilicization of these polyurethane dispersions.

It is also preferred that (I) the specific polyurethane dispersions have a low degree of hydrophilic anionic groups. It is more preferred that these polyurethane dispersions have from 0.1 to 15 milliequivalents of anionic or potentially anionic groups per 100 g of solid polyurethane (i.e. solid resin).

To achieve good sedimentation stability, the number average particle size of the specific polyurethane dispersions is preferably less than 750 nm and more preferably less than 500 nm. As used herein, the number average particle size is determined by laser correlation spectroscopy.

The solids contents of (I) the polyurethane dispersions are preferably in the range from 30% to 70% by weight, more preferably in the range from 50% to 70% by weight and most preferably in the range from 55% to 65% by weight, and especially from 60% to 65% by weight based on the polyurethane present therein.

The level of unbound organic amines in these polyurethane dispersions is preferably less than 0.5% by weight, and more preferably less than 0.2% by weight, based on 100% by weight of the polyurethane dispersions.

The preferred polyurethane dispersions (I) herein comprise the reaction product of:
A) one or more isocyanate-functional prepolymers which comprise the reaction product of:
   A1) at least one organic polyisocyanate, with
   A2) at least one polymeric polyol having a number-average molecular weight in the range from 400 to 8000 g/mol, preferably in the range from 400 to 6000 g/mol and more preferably in the range from 600 to 30 000 g/mol, and an OH functionality in the range from 1.5 to 6, preferably in the range from 1.8 to 3 and more preferably in the range from 1.9 to 2.1, and
   A3) optionally, one or more hydroxyl-functional compounds having molecular weights in the range from 62 to 399 g/mol, and
   A4) optionally, one or more isocyanate-reactive, anionic or potentially anionic and/or optionally nonionic hydrophilicizing agents; with
B) one or more compounds selected from the group consisting of:
   B1) optionally, one or more amino-functional compounds having molecular weights in the range from 32 to 400 g/mol, and
   B2) optionally, one or more amino-functional, anionic or potentially anionic hydrophilicizing agents;
      in which the free NCO groups are completely or partially reacted by chain extension, and in which the prepolymers being dispersed in water before, during or after the reaction with component B)

If desired, the prepolymer can be completely or partially converted into the anionic form by admixing a base, before, during or after dispersion in water.

To achieve anionic hydrophilicization, components A4) and/or B2) contain hydrophilicizing agents that have at least one NCO-reactive group such as amino, hydroxyl and/or thiol groups, and additionally have —COO⁻ or —SO₃⁻ or —PO₃²⁻ as anionic groups or their wholly or partly protonated acid forms as potential anionic groups.

It is preferred that components A4) and/or B2) utilize such compounds for anionic or potentially anionic hydrophilicization which have exclusively sulfonic acid or sulfonate groups (i.e. −SO₃H or —SO₃M, wherein M represents an alkali metal or an alkaline earth metal) as anionic or potentially anionic functionality.

### DETAILED DESCRIPTION OF THE INVENTION

Suitable polyisocyanates of component A1) are the well-known aliphatic or cycloaliphatic polyisocyanates having an NCO functionality of not less than 2. Examples of such suitable polyisocyanates are 1,4-butylene diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanato-cyclohexyl)methane or their mixtures of any desired isomer content, 1,4-cyclo-hexylene diisocyanate, 4-isocyanatomethyl-1,8-octane diisocyanate(nonane triisocyanate) and also alkyl 2,6-diisocyanatohexanoates (i.e. lysine diisocyanates) having C1-C8-alkyl groups.

In addition to the aforementioned polyisocyanates, it is also possible to use modified diisocyanates having a functionality ≧2 and a uretidione, isocyanurate, urethane, allophanate, biuret, iminooxadiazinedione or oxadiazinetrione structure, and also mixtures thereof pro rata.

Preferably, the polyisocyanates or polyisocyanate mixtures of the aforementioned type have exclusively aliphatically and/or cycloaliphatically attached isocyanate groups, and an average NCO functionality in the range from 2 to 4, preferably in the range from 2 to 2.6 and more preferably in the range from 2 to 2.4, for the mixture.

It is particularly preferred for component A1) to comprise hexamethylene diisocyanate, isophorone diisocyanate or the isomeric bis(4,4′-isocyanatocyclohexyl)methanes or also mixtures thereof.

Component A2) comprises at least one polymeric polyol having a number average molecular weight Mₙ in the range from 400 to 8000 g/mol, preferably from 400 to 6000 g/mol and more preferably from 600 to 3000 g/mol. These polymeric polyols preferably have an OH functionality in the range from 1.5 to 6, more preferably in the range from 1.8 to 3 and most preferably in the range from 1.9 to 2.1.

Such polymeric polyols are the well-known polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols which are commonly used in polyurethane coating technology. These can be used either individually or in any desired mixtures with one another as component A2).

These polyester polyols are the well-known polycondensates formed from di- and also optionally tri- and tetraols with di- and also optionally tri- and tetracarboxylic acids or hydroxy carboxylic acids or lactones. Instead of the free polycarboxylic acids it is also possible to use the corresponding polycarboxylic anhydrides or corresponding polycarboxylic esters of lower alcohols for preparing the polyesters.

Examples of suitable diols are ethylene glycol, butylene glycol, diethylene glycol, triethylene glycol, polyalkylene glycols such as polyethylene glycol, as well as 1,2-propanediol, 1,3-propanediol, butanediol(1,3), butanediol(1,4), hexanediol(1,6) and isomers, neopentyl glycol or neopentyl glycol hydroxy-pivalate. Preferred diols include hexanediol(1,6) and isomers thereof, butanediol(1,4), neopentyl glycol and neopentyl glycol hydroxypivalate. In addition to these, it is also possible to use polyols such as trimethylolpropane, glycerol, erythritol, pentaerythritol, trimethylolbenzene or trishydroxyethyl isocyanurate.

Suitable dicarboxylic acids include, for example, phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethyl glutaric acid and/or 2,2-dimethylsuccinic acid. The corresponding anhydrides can also be used as a source of an acid.

When the average functionality of the polyol to be esterified is greater than 2, monocarboxylic acids, such as benzoic acid and hexanecarboxylic acid can be used as well.

Preferred carboxylic acids are aliphatic or aromatic acids of the aforementioned kind. Adipic acid, isophthalic acid and phthalic acid are particularly preferred.

Hydroxy carboxylic acids which are useful reactants in the preparation of a polyester polyol having terminal hydroxyl groups include, for example, hydroxy-caproic acid, hydroxybutyric acid, hydroxydecanoic acid, hydroxystearic acid and the like. Suitable lactones include caprolactone, butyrolactone and homologues. Caprolactone is preferred.

Likewise, component A2) may comprise at least one hydroxyl-containing polycarbonate, preferably at least one polycarbonatediol, having a number average molecular weight Mₙ in the range from 400 to 8000 g/mol and preferably in the range from 600 to 3000 g/mol. These are obtainable by reaction of carbonic acid derivatives, such as diphenyl carbonate, dimethyl carbonate or phosgene, with polyols, preferably diols.

Examples of such diols are ethylene glycol, 1,2-propanediol, 1,3-propanediol, 1,3-butanediol, 1,4-butanediol, 1,6-hexanediol, 1,8-octanediol, neopentyl glycol, 1,4-bishydroxymethylcyclohexane, 2-methyl-1,3-propanediol, 2,2,4-trimethyl-1,3-pentanediol, dipropylene glycol, polypropylene glycols, dibutylene glycol, polybutylene glycols, bisphenol A and lactone-modified diols of the aforementioned kind.

The polycarbonate diol component preferably contains 40% to 100% by weight of hexanediol, preference being given to 1,6-hexanediol and/or hexanediol derivatives. Such hexanediol derivatives are based on hexanediol and have ester or ether groups as well as terminal OH groups. Such derivatives are obtainable by reaction of hexanediol with excess caprolactone or by etherification of hexanediol with itself to form di- or trihexylene glycol.

In lieu of or in addition to pure polycarbonate diols, polyether-polycarbonate diols are also suitable for use as A2) a polymeric polyol.

Hydroxyl-containing polycarbonates preferably have a linear construction.

Component A2) may likewise at least one polyether polyol.

Suitable polyether polyols include for example the well-known polytetramethylene glycol polyethers which are obtainable by polymerization of tetrahydrofuran by means of cationic ring opening. Such polyether polyols are known and described in various texts dealing with polyurethane chemistry.

Suitable polyether polyols likewise include the well-known addition products of styrene oxide, ethylene oxide, propylene oxide, butylene oxides and/or epichlorohydrin onto di- or polyfunctional starter molecules. The polyether polyols based on the at least proportional addition of ethylene oxide onto di- or polyfunctional starter molecules can also be used as component A4) (i.e. nonionic hydrophilicizing agents).

Suitable starter molecules for the preparation of polyether polyols include all known hydroxyl-group and/or amine-group containing compounds such as, for example water, butyl diglycol, glycerol, diethylene glycol, trimethylolpropane, propylene glycol, sorbitol, ethylenediamine, triethanolamine, 1,4-butanediol, etc.

Component A3) may utilize polyols of the specified molecular weight range with up to 20 carbon atoms, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)-propane), hydrogenated bisphenol A, (2,2-bis(⁴-hydroxycyclohexyl)propane), trimethylolpropane, glycerol, pentaerythritol and also any desired mixtures thereof with one another.

Also suitable are esterdiols of the specified molecular weight range such as, for example, α-hydroxybutyl-ε-hydroxycaproic acid ester, ω-hydroxyhexyl-γ-hydroxybutyric acid ester, β-hydroxyethyl adipate or bis(β-hydroxyethyl) terephthalate.

Component A3) may additionally comprise monofunctional isocyanate-reactive hydroxyl-containing compounds. Examples of such monofunctional compounds are ethanol, n-butanol, ethylene glycol monobutyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1 -dodecanol, 1-hexadecanol, etc.

Component A4) herein which is also optional, comprises one or more isocyanate-reactive, anionic or potentially anionic and optionally non-ionic hydrophilicizing agents. Thus, the suitable isocyanate-reactive hydrophilicizing agents herein additionally contain one or more of anionic groups, potentially anionic groups and/or non-ionic groups.

Suitable anionically hydrophilicizing compounds to be used as component A4) include salts of mono- and dihydroxy sulfonic acids. Examples of such anionic hydrophilicizing agents are the adduct of sodium bisulfite onto 2-butene-1,4-diol as described in DE-A 2 446 440, pages 5-9, formula I-III, which is believed to correspond to U.S. Pat. No. 4,108,814, the disclosure of which is hereby incorporated by reference.

Suitable nonionically hydrophilicizing compounds to be used as component A4) include, for example, polyoxyalkylene ethers containing at least one hydroxyl, amino or thiol group. Examples of these are the monohydroxyl-functional polyalkylene oxide polyether alcohols containing on average 5 to 70 and preferably 7 to 55 ethylene oxide units per molecule, and obtainable in a conventional manner by alkoxylation of suitable starter molecules. Such a process is described in, for example, Ullmanns Encyclopädie der technischen Chemie, 4th edition, volume 19, Verlag Chemie, Weinheim pages 31-38. These are either pure polyethylene oxide ethers or mixed polyalkylene oxide ethers, containing at least 30 mol % and preferably at least 40 mol % of ethylene oxide units, based on all alkylene oxide units present.

Obviously, such compounds can not be simultaneously used as components A2) and A4). Thus, if component A2) comprises a polyether polyol prepared by addition of ethylene oxide onto suitable starter molecules, then component A4) is another type of hydrophilicizing agent. Similarly, if component A4) comprises a polyethylene oxide ether then component A2) is another type of polymeric polyol. In this manner, components A2) and A4) are mutually exclusive.

Particularly preferred nonionic compounds are monofunctional mixed polyalkylene oxide polyethers having 40 to 100 mol % of ethylene oxide units and 0 to 60 mol % of propylene oxide units.

Suitable starter molecules for such nonionic hydrophilicizing agents include saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers such as, for example diethylene glycol monobutyl ether, unsaturated alcohols such as allyl alcohol, 1,1-dimethylallyl alcohol or oleic alcohol, aromatic alcohols such as phenol, the isomeric cresols or methoxy-phenols, araliphatic alcohols such as benzyl alcohol, anisal alcohol or cinnamyl alcohol, secondary monoamines such as dimethylamine, diethylamine, dipropylamine, diisopropylamine, dibutylamine, bis(2-ethylhexyl)amine, N-methylcyclohexylamine, N-ethylcyclohexylamine or dicyclohexylamine and also heterocyclic secondary amines such as morpholine, pyrrolidine, piperidine or 1 H pyrazole. Preferred starter molecules are saturated monoalcohols of the aforementioned kind. Particular preference is given to using diethylene glycol monobutyl ether or n-butanol as starter molecules.

The useful alkylene oxides for the alkoxylation reaction are, in particular, ethylene oxide and propylene oxide, which can be used in any desired order or else in admixture in the alkoxylation reaction.

Suitable compounds to be used as component B1) in accordance with the present invention include organic di- or polyamines such as for example 1,2-ethylene-diamine, 1,2-diaminopropane, 1,3-diaminopropane, 1,3-diaminobutane, 1,6-diaminohexane, isophoronediamine, isomeric mixtures of 2,2,4- and 2,4,4-tri-methylhexamethylenediamine, 2-methylpentamethylenediamine, diethylene-triamine, 4,4-diaminodicyclohexylmethane and/or dimethylethylenediamine.

Component B1) can also include compounds which, in addition to a primary amino group, also have one or more secondary amino groups or which have both an amino group (e.g. primary or secondary) and one or more OH groups. Examples thereof are primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine, etc.

In addition, component B1) can comprise monofunctional isocyanate-reactive amine compounds, for example, methylamine, ethylamine, propylamine, butylamine, octylamine, laurylamine, stearylamine, isononyloxypropylamine, dimethylamine, diethylamine, dipropylamine, dibutylamine, N-methylamino-propylamine, diethyl(methyl)aminopropylamine, morpholine, piperidine, or suitable substituted derivatives thereof, amide-amines formed from diprimary amines and monocarboxylic acids, monoketimes of diprimary amines, primary/tertiary amines, such as N,N-dimethylaminopropylamine.

Suitable anionically hydrophilicizing compounds for component B2) include alkali metal salts of the mono- and diamino sulfonic acids. Examples of such anionic hydrophilicizing agents are salts of 2-(2-aminoethylamino)ethane-sulfonic acid, ethylenediaminepropylsulfonic acid, ethylenediaminebutylsulfonic acid, 1,2- or 1,3-propylenediamine-β-ethylsulfonic acid or taurine. It is also possible to use the salt of cyclohexylaminopropanesulfonic acid (CAPS) as an anionic hydrophilicizing agent as is described in WO-A 01/88006, which is believed to correspond to U.S. Pat. No. 6,767,959, the disclosure of which is hereby incorporated by reference.

Preferred anionic hydrophilicizing agents for component B2) are those which contain sulfonate groups as ionic groups and two amino groups. Examples of such compounds include the salts of 2-(2-aminoethylamino)ethylsulfonic acid and 1,3-propylenediamine-β-ethylsulfonic acid.

Mixtures of anionic and nonionic hydrophilicizing agents can also be used as component B2).

A preferred embodiment for producing the specific polyurethane dispersions comprises components A1) to A4) and B1) to B2) in the following amounts, with the sum of the individual amounts always adding up to 100% by weight:

5% to 40% by weight of component A1),

55% to 90% by weight of A2),

0.5% to 20% by weight of the sum total of components A3) and B1), and

0.1% to 25% by weight of the sum total of the components A4) and B2), wherein from 0.1 to 5% by weight of anionic or potentially anionic hydrophilicizing agents from components A4) and/or B2) are present, based on 100% by weight of components A1) to A4) and B1) to B2).

A particularly preferred embodiment for producing the specific polyurethane dispersions comprises components A1) to A4) and B1) to B2) in the following amounts, with the sum of the individual amounts always adding up to 100% by weight:

5% to 35% by weight of component A1),

60% to 90% by weight of A2),

0.5% to 15% by weight of the sum total of components A3) and B1), and

0.1% to 15% by weight of the sum total of the components A4) and B2), wherein from 0.2 to 4% by weight of anionic or potentially anionic hydrophilicizing agents from components A4) and/or B2) are present, based on 100% by weight of components A1) to A4) and B1) to B2).

A very particularly preferred embodiment for producing the specific polyurethane dispersions comprises components A1) to A4) and B1) to B2) in the following amounts, with the sum of the individual amounts always adding up to 100% by weight:

10% to 30% by weight of component A1),

65% to 85% by weight of A2),

0.5% to 14% by weight of the sum total of components A3) and B1), and

0. 1% to 13.5% by weight of the sum total of the components A4) and B2), wherein from 0.5 to 3.0% by weight of anionic or potentially anionic hydrophilicizing agents from components A4) and/or B2) are present, based on 100% by weight of components A1) to A4) and B1) to B2).

The production of (I) the specific polyurethane dispersions can be carried out in one or more stages in homogeneous phase or, in the case of a multistage reaction, partly in disperse phase. After completely or partially conducted polyaddition from A1) to A4), a dispersing, emulsifying or dissolving step is carried out. This is followed, if appropriate, by a further polyaddition or modification in disperse phase.

Any of the known process can be used. Specific examples of such processes being the prepolymer mixing process, the acetone process or the melt dispersing process. The acetone process is preferred.

Production by the acetone process typically involves the constituents A2) to A4) and the polyisocyanate component A1) being wholly or partly introduced as an initial charge to produce an isocyanate-functional polyurethane prepolymer, and optionally diluted with a water-miscible but isocyanate-inert solvent and heated to temperatures in the range from 50 to 120° C. The rate of the isocyanate addition reaction can be increased using the catalysts known in polyurethane chemistry.

Useful solvents include the customary aliphatic, keto-functional solvents such as acetone, 2-butanone, etc., which can be added not just at the start of the production process but also later, and optionally in portions. Acetone and 2-butanone are preferred and acetone is particularly preferred.

Subsequently, any constituents of A1) to A4) not added at the start of the reaction are added.

In the production of A) the isocyanate-functional prepolymer from components A1) to A4), the molar ratio of isocyanate groups to isocyanate-reactive groups is in the range from 1.05 to 3.5, preferably in the range from 1.1 to 3.0 and more preferably in the range from 1.1 to 2.5.

The reaction of components A1) to A4) to form the prepolymer is effected partially or completely, but preferably completely. Isocyanate-functional prepolymers which contain free isocyanate groups are obtained in this way, without a solvent or in solution.

Subsequently, in a further process step, if this has not already been done or has only partially been done, the resultant prepolymer is dissolved with the aid of aliphatic ketones such as acetone or 2-butanone.

In the chain extension of the isocyanate-functional prepolymers A) with component B), the NH₂— and/or NH-functional components are reacted by chain extension with the still remaining isocyanate groups of the prepolymer. Preferably, the chain extension/termination is carried out before dispersion of the prepolymers in water.

Chain-extending components include organic di- or polyamines as component B1) such as, for example, ethylenediamine, 1,2-diaminopropane, 1,3-diaminopropane, 1,4-diaminobutane, 1,6-diaminohexane, isophoronediamine, isomeric mixture of 2,2,4- and 2,4,4-trimethylhexamethylenediamine, 2-methylpentamethylene-diamine, diethylenetriamine, diaminodicyclohexylmethane and/or dimethyl-ethylendiamine.

In addition, it is also possible to employ compounds B1) which, as well as a primary amino group, also have secondary amino groups or which have also have one or more OH groups in addition to an amino group (e.g. primary or secondary). Examples of such compounds include primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanol-amines such as N-aminoethylethanolamine, ethanolamine, 3-aminopropanol, neopentanolamine for chain extension or termination.

Chain termination is typically carried out using component B1) one or more amines having an isocyanate-reactive group such as methylamine, ethylamine, propylamine, butylamine, octylamine, laurylamine, stearylamine, isononyl-oxypropylamine, dimethylamine, diethylamine, dipropylamine, dibutylamine, N-methylaminopropylamine, diethyl(methyl)aminopropylamine, morpholine, piperidine or suitable substituted derivatives thereof, amide amines formed from diprimary amines and monocarboxylic acids, monoketimes of diprimary amines, primary/tertiary amines, such as N,N-dimethylamino-propylamine, etc.

When chain extension is carried out using component B2) an anionic hydrophilicizing agent as described above and which contains NH₂ or NH groups, the chain extension of the prepolymers is preferably carried out before dispersion of the prepolymers in water.

The degree of chain extension, i.e. the equivalent ratio of NCO-reactive groups of the compounds used for chain extension and chain termination to free NCO groups of the prepolymer, is between 40 to 150%, preferably between 50 to 120% and more preferably between 60 to 120%.

The aminic components B1) and B2) can optionally be used in water- or solvent-diluted form in the process of the present invention, individually or in mixtures, any order of addition being possible in principle.

When water or organic solvent is used as a diluent, the diluent content of component B) is preferably in the range from 70% to 95% by weight, based on 100% by weight of component B).

Dispersion of the prepolymer is preferably carried out following chain extension. For dispersion, the dissolved and chain-extended polyurethane polymer is either introduced into the dispersing water, if appropriate by substantial shearing, such as vigorous stirring for example, or conversely the dispersing water is stirred into the chain-extended polyurethane polymer solutions. It is preferable to add the water to the dissolved chain-extended polyurethane polymer.

Any solvent that is still present in the dispersions after the dispersing step is then typically removed by distillation. Removal during the dispersing step is likewise possible.

The residual level of organic solvents in (I) the polyurethane dispersions which are essential to the present invention is typically less than 1% by weight and preferably less than 0.5% by weight, based on 100% by weight of the dispersion.

The pH of (I) the polyurethane dispersions which are essential to the present invention is typically less than 8.0, preferably less than 7.5 and more preferably between 5.5 and 7.5.

In addition to (I) the polyurethane dispersions, the compositions which are to be frothed may also contain (II) one or more auxiliary agents and/or additive materials.

Examples of such materials to be used as (II) auxiliary agents and/or additive materials include foam auxiliaries such as foam formers and stabilizers, thickeners or thixotroping agents, antioxidants, light stabilizers, emulsifiers, plasticizers, pigments, fillers and/or flow control agents.

It is preferred that foam auxiliaries such as foam formers and stabilizers are included as (II) auxiliary agents and/or additive materials. Useful foam auxiliaries include, for example, commercially available compounds such as fatty acid amides, hydrocarbyl sulfates or sulfonates or fatty acid salts, in which case the lipophilic radical preferably contains 12 to 24 carbon atoms, as well as alkylpoly-glycosides, which are in principle known in prior art and which can be produced by reaction of long chain monoalcohols with 4 to 22 C atoms in the alkyl chain, with mono-, di- and polysaccharides, respectively (see for example Kirk-Othmer, Encyclopedia of Chemical Technology, John Wiley & Sons, Vol. 24, S. 29).

Preferred foam auxiliaries are sulfosuccinamides, alkanesulfonates or alkyl sulfates having 12 to 22 carbon atoms in the hydrocarbyl radical, alkylbenzene-sulfonates or alkylbenzene sulfates having 14 to 24 carbon atoms in the hydrocarbyl radical or fatty acid amides or fatty acid salts having 12 to 24 carbon atoms.

Such fatty acid amides are preferably based on mono- or di-(C2-C3-alkanol)-amines. The fatty acid salts may be for example alkali metal salts, amine salts or unsubstituted ammonium salts.

Such fatty acid derivatives are typically based on fatty acids such as lauric acid, myristic acid, palmitic acid, oleic acid, stearic acid, ricinoleic acid, behenic acid or arachidic acid, coco fatty acid, tallow fatty acid, soya fatty acid and their hydrogenation products.

Particularly preferred foam auxiliaries are mixtures of sulfosuccinamides and ammonium stearates. These mixtures preferably comprise from 20% to 60% by weight and more preferably 30% to 50% by weight of ammonium stearates, and preferably 80% to 40% by weight and more preferably 70% to 50% by weight of sulfosuccinamides, in which the sum of the %'s by weight of the ammonium stearates and sulfosuccinamides totals 100% by weight of the mixture.

Commercially available thickeners can be used. Suitable thickeners include derivatives of dextrin, of starch or of cellulose such as, for example, cellulose ethers or hydroxyethylcellulose, organic wholly synthetic thickeners based on polyacrylic acids, polyvinylpyrrolidones, polymethacrylic compounds or polyurethanes (associative thickeners) and also inorganic thickeners, such as bentonites or silicas.

Frothing in the process of the present invention is accomplished by mechanical stirring of the composition at high speeds of rotation by shaking or by decompressing a blowing gas.

Mechanical frothing can be effected using any desired mechanical stirring, mixing and/or dispersing techniques. Air is generally introduced, but nitrogen and other gases can also be used for this purpose.

The polyurethane foam thus obtained is, in the course of frothing or immediately thereafter, applied to a substrate or introduced into a mold and dried.

Application of the polyurethane foam to a substrate can be, for example, by casting or blade coating, but other conventional techniques are also possible. Multilayered application with intervening drying steps is also possible in principle.

A satisfactory drying rate for the polyurethane foams is observed at a temperature as low as 20° C., so that drying on injured human or animal tissue presents no problem. However, temperatures above 30° C. are preferably used for more rapid drying and fixing of the foams. Drying temperatures should not, however, exceed 200° C., preferably 150° C. and more preferably 130° C., since undesirable yellowing of the foams can otherwise occur, inter alia. Drying of the foams in two or more stages is also possible.

Drying is generally effected using conventional heating and drying apparatus, such as (circulating air) drying cabinets, hot air or IR radiators.

Application and drying of the polyurethane foams can each be carried out batchwise or continuously, but the entirely continuous process is preferred.

Useful substrates on which the polyurethane foams can be applied include papers or films which facilitate simple detachment of the wound contact material before it is used to cover an injured site. Human or animal tissue such as skin can similarly serve as a substrate, so that direct closure of an injured site is possible by a wound contact material produced in situ.

The present invention further provides the wound contact materials obtainable by the process of the present invention.

Before drying, the foam densities of the polyurethane foams are typically in the range from 50 to 800 g/liter, preferably in the range from 100 to 500 g/liter and more preferably in the range from 100 to 250 g/liter (mass of all input materials [in g] based on the foam volume of one liter).

After drying, the polyurethane foams have a microporous, open-cell structure comprising intercommunicating cells. The density of the dried foams is typically below 0.4 g/cm³, preferably below 0.35 g/cm³ , more preferably 0.01 to 0.3 g/cm³ and most preferably in the range from 0.15 to 0.3 g/cm³.

In accordance with the present invention, these dried polyurethane foams typically have a physiological saline absorbency, as measured by DIN EN 13726-1 Part 3.2, in the range of 100 to 1500%, preferably 300 to 1500%, and more preferably in the range from 300 to 800% (mass of absorbed liquid, based on the mass of dry foam). In addition, these dried polyurethane foams have a water vapor transmission rate, as measured by DIN EN 13716-2 Part 3.2, in the range from 2000 to 8000 g/24 h*m², and preferably in the range from 3000 to 8000 g/24 h*m², more preferably in the range from 3000 to 5000 g/24 h*m².

The polyurethane foams exhibit good mechanical strength and high elasticity. Typically, maximum stress of the foams is greater than 0.2 N/mm² and maximum extension of the foams is greater than 250%. Preferably, maximum stress of the foams is greater than 0.4 N/mm² and the extension is greater than 350% (determined according to DIN 53504).

After drying, the thickness of the polyurethane foams is typically in the range from 0.1 mm to 50 mm, preferably in the range from 0.5 mm to 20 mm, more preferably in the range from 1 to 10 mm and most preferably in the range from 1 to 5mm.

The polyurethane foams can moreover be adhered, laminated or coated to or with further materials such as, for example, materials based on hydrogels, (semi-) permeable films, coatings, hydrocolloids or other foams.

If appropriate, a sterilizing step can be included in the process of the present invention. It is similarly possible, at least in principle, for wound contact materials obtainable by the process of the present invention to be sterilized after they have been produced. Conventional sterilizing processes are used where sterilization is effected by thermal treatment chemicals such as ethyleneoxide or irradiation with gamma rays for example.

It is likewise possible to add, incorporate or coat with antimicrobially or biologically active components. Such antimicrobially or biologically active components include, for example, those which have a positive effect with regard to wound healing and the avoidance of germ loads.

Due to the wide utility of the process of the present invention and of the polyurethane wound dressing foams obtainable thereby, it is possible in principle to use said process in the industrial production of wound dressing foams. It is similarly also possible to use it for producing sprayed plasters, for example, in which case the polyurethane wound dressing foam is formed by direct application of the polyurethane foam forming composition to a wound, with simultaneous frothing, and subsequent drying.

For industrial production of polyurethane wound dressing foams, component (I) the polyurethane dispersion is mixed with optional component (II) auxiliary agents and/or additive materials of the aforementioned kind, and thereafter mechanically frothed by introduction of a gas such as air. This foam is applied to a substrate and physically dried. Owing to higher productivity, drying is typically carried out at elevated temperatures in the range from 30 to 200° C., preferably in the range from 50 to 150° C. and more preferably in the range from 60 to 130° C. Preference is further given to an at least two-stage drying process, beginning at temperatures of 40 to 80° C. and with subsequent further drying at elevated temperatures of 80 to 140° C. Drying is generally carried out using conventional heating and drying apparatuses such as, for example, (circulating air) drying cabinets. Application and drying can each be carried out batchwise or continuously, but preference is given to the wholly continuous process. For sterilization, a sterilizing step can be carried out during or after the process, by irradiation or addition of suitable substances.

When the compositions of the present invention are used to produce a spray plaster, component (I) the polyurethane dispersion is formulated with optional component (II) an auxiliary agent and/or additive material which preferably comprises a foam auxiliary and a blowing agent, so that frothing ensues coterminous with spraying. To consolidate the foam formed, the foam is subsequently dried, for which temperatures of 20 to 40° C. are sufficient. When additional heat sources such as a hair dryer or an IR red light lamp are used, however, forced thermal drying up to a maximum temperature of 80° C. is possible.

The blowing agents suitable herein include those which are known in polyurethane chemistry. Suitable propellants are for example n-butane, i-butane and propane and any mixtures of these hydrocarbons. Equally suitable as propellant is also dimethylether. Preferably, a mixture selected from n-butane, i-butane and propane is used as propellant and the desired, fine-porous foams can be obtained. The propellant or the mixture of propellants is typically used in an amount from 1 to 50 wt.-%, preferably 5 to 40 wt.-%, and particularly preferred 5 to 20 wt.-%, whereas the percentage of the polyurethane dispersion (I), propellant(s) and auxiliary agents/additive materials (II) is equal to 100 wt.-%. Spray plasters are preferably provided in spray cans. Casting of the composition is possible as well as spraying.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

Unless indicated otherwise, all analytical measurements relate to temperatures of 23° C.

Solids contents were determined in accordance with DIN-EN ISO 3251.

NCO contents were determined, unless explicitly stated otherwise, volumetrically in accordance with DIN-EN ISO 11909.

Free NCO groups were monitored by IR spectroscopy (band at 2260 cm⁻¹).

The reported viscosities were determined by rotary viscometry in accordance with DIN 53019 at 23° C. using a rotary viscometer from Anton Paar Germany GmbH, Ostfildern, Germany.

The following substances were used in the examples:

| | |
|---|---|
| Diaminosulfonate: | NH₂—CH₂CH₂—NH—CH₂CH₂—SO₃Na (45% in water) |
| Polyol 1: | Polycarbonate polyol having an OH number of |
| | 56 mg KOH/g, and a number average molecular |
| | weight of 2000 g/mol (commercially available as |
| | Desmophen ® 2020/C2200 from Bayer |
| | MaterialScience AG, Leverkusen, Germany) |
| Polyol 2: | Polytetramethylene glycol polyol having an OH |
| | number of 56 mg KOH/g, and a number average |
| | molecular weight of 2000 g/mol (commercially |
| | available as PolyTHF ® 2000 from BASF AG, |
| | Ludwigshafen, Germany) |
| Polyol 3: | Polytetramethylene glycol polyol having an OH |
| | number 112 mg KOH/g, and a number average |
| | number average molecular weight of 1000 g/mol |
| | (commercially available as PolyTHF ® 1000 from |
| | BASF AG, Ludwigshafen, Germany) |
| Polyol 4: | Monofunctional polyether based on ethylene |
| | oxide/propylene oxide, having a number average |
| | molecular weight of 2250 g/mol, and an OH number |
| | of 25 mg KOH/g (commercially available as LB 25 |
| | polyether from Bayer MaterialScience AG, Leverkusen, Germany) |
| Stokal ® STA: | Foam auxiliary aid based on ammonium stearate, |
| | active ingredient content: 30% (commercially |
| | available from Bozzetto GmbH, Krefeld, Germany) |
| Stokal ® SR: | Foam auxiliary aid based on succinamate, active |
| | ingredient content: about 34% (commercially |
| | available from Bozzetto GmbH, Krefeld, Germany) |
| Simulsol ™ SL 26: | alkylpolyglycoside based on dodecylalcohol, about 52% aqueous |
| | solution, Seppic GmbH, Cologne, DE |

The mean of the average particle sizes (the number average of which is reported) of the polyurethane dispersions (I) were determined using laser correlation spectroscopy. (Specifically, the instrument used was a Malvern Zetasizer 1000, Malver Inst. Limited.)

### Example 1

### Polyurethane Dispersion 1

987.0 g of Polyol 2, 375.4 g of Polyol 3, 761.3 g of Polyol 1 and 44.3 g of Polyol 4 were heated to 70° C. in a standard stirring apparatus. Then, a mixture of 237.0 g of hexamethylene diisocyanate and 313.2 g of isophorone diisocyanate was added at 70° C. over the course of 5 minutes, and the mixture was stirred at 120° C. until the theoretical NCO value was reached or the actual NCO value was slightly below the theoretical NCO value. The ready-produced prepolymer was dissolved with 4830 g of acetone and, during the process, cooled down to 50° C., and subsequently admixed with a solution of 25.1 g of ethylenediamine, 116.5 g of isophoronediamine, 61.7 g of diaminosulfonate and 1030 g of water metered in over 10 minutes. The mixture was subsequently stirred for 10 minutes. Then, a dispersion was formed by addition of 1250 g of water. This was followed by removal of the solvent by distillation under reduced pressure.

The white dispersion obtained had the following properties:

| | |
|---|---|
| Solids content: | 61% |
| Particle size (LKS): | 312 nm |
| Viscosity (viscometer, 23° C.): | 241 mPas |
| pH (23° C.): | 6.02 |

### Example 2

### Polyurethane Dispersion 2

223.7 g of Polyol 2, 85.1 g of Polyol 3, 172.6 g of Polyol 1 and 10.0 g of Polyol 4 were heated to 70° C. in a standard stirring apparatus. Then, a mixture of 53.7 g of hexamethylene diisocyanate and 71.0 g of isophorone diisocyanate was added at 70° C. over the course of 5 minutes, and the mixture was stirred at 120° C. until the theoretical NCO value was reached or the actual NCO value was slightly below the theoretical NCO value. The ready-produced prepolymer was dissolved with 1005 g of acetone and, in the process, cooled down to 50° C. and subsequently admixed with a solution of 5.70 g of ethylenediamine, 26.4 g of isophoronediamine, 9.18 g of diaminosulfonate and 249.2 g of water metered in over 10 minutes. The mixture was subsequently stirred for 10 minutes. Then, a dispersion was formed by addition of 216 g of water. This was followed by removal of the solvent by distillation under reduced pressure.

The white dispersion obtained had the following properties:

| | |
|---|---|
| Solids content: | 63% |
| Particle size (LKS): | 495 nm |
| Viscosity (viscometer, 23° C.): | 133 mPas |
| pH (23° C.): | 6.92 |

### Example 3

### Polyurethane Dispersion 3

987.0 g of Polyol 2, 375.4 g of Polyol 3, 761.3 g of Polyol 1 and 44.3 g of Polyol 4 were heated to 70° C. in a standard stirring apparatus. Then, a mixture of 237.0 g of hexamethylene diisocyanate and 313.2 g of isophorone diisocyanate was added at 70° C. over the course of 5 minutes and the mixture was stirred at 120° C. until the theoretical NCO value was reached or the actual NCO value was slightly below the theoretical NCO value. The ready-produced prepolymer was dissolved with 4830 g of acetone and, in the process, cooled down to 50° C., and subsequently admixed with a solution of 36.9 g of 1,4-diaminobutane, 116.5 g of isophoronediamine, 61.7 g of diaminosulfonate and 1076 g of water metered in over 10 minutes. The mixture was subsequently stirred for 10 minutes. Then, a dispersion was formed by addition of 1210 g of water. This was followed by removal of the solvent by distillation under reduced pressure.

The white dispersion obtained had the following properties:

| | |
|---|---|
| Solids content: | 59% |
| Particle size (LKS): | 350 nm |
| Viscosity (viscometer, 23° C.): | 126 mPas |
| pH (23° C.): | 7.07 |

### Example 4

### Polyurethane Dispersion 4

201.3 g of Polyol 2, 76.6 g of Polyol 3, 155.3 g of Polyol 1, 2.50 g of 1,4-butanediol and 10.0 g of Polyol 4 were heated to 70° C. in a standard stirring apparatus. Then, a mixture of 53.7 g of hexamethylene diisocyanate and 71.0 g of isophorone diisocyanate was added at 70° C. over the course of 5 minutes and the mixture was stirred at 120° C. until the theoretical NCO value was reached or the actual NCO value was slightly below the theoretical NCO value. The ready-produced prepolymer was dissolved with 1010 g of acetone and, in the process, cooled down to 50° C. and subsequently admixed with a solution of 5.70 g of ethylenediamine, 26.4 g of isophoronediamine, 14.0 g of diaminosulfonate and 250 g of water metered in over 10 minutes. The mixture was subsequently stirred for 10 minutes. Then, a dispersion was formed by addition of 243 g of water. This was followed by removal of the solvent by distillation under reduced pressure.

The white dispersion obtained had the following properties:

| | |
|---|---|
| Solids content: | 62% |
| Particle size (LKS): | 566 nm |
| Viscosity (viscometer, 23° C.): | 57 mPas |
| pH (23° C.): | 6.64 |

### Example 5

### Polyurethane Dispersion 5

201.3 g of Polyol 2, 76.6 g of Polyol 3, 155.3 g of Polyol 1, 2.50 g of trimethylolpropane and 10.0 g of Polyol 4 were heated to 70° C. in a standard stirring apparatus. Then, a mixture of 53.7 g of hexamethylene diisocyanate and 71.0 g of isophorone diisocyanate was added at 70° C. over the course of 5 minutes, and the mixture was stirred at 120° C. until the theoretical NCO value was reached or the actual NCO value was slightly below the theoretical NCO value. The ready-produced prepolymer was dissolved with 1010 g of acetone and, in the process, cooled down to 50° C. and subsequently admixed with a solution of 5.70 g of ethylenediamine, 26.4 g of isophoronediamine, 14.0 g of diaminosulfonate and 250 g of water metered in over 10 minutes. The mixture was subsequently stirred for 10 minutes. Then, a dispersion was formed by addition of 293 g of water. This was followed by removal of the solvent by distillation under reduced pressure.

The white dispersion obtained had the following properties:

| | |
|---|---|
| Solids content: | 56% |
| Particle size (LKS): | 440 nm |
| Viscosity (viscometer, 23° C.): | 84 mPas |
| pH (23° C.): | 6.91 |

### Example 6

### Polyurethane Dispersion 6

1072 g of Polyol 2, 407.6 g of Polyol 3, 827 g of Polyol 1 and 48.1 g of Polyol 4 were heated to 70° C. in a standard stirring apparatus. Then, a mixture of 257.4 g of hexamethylene diisocyanate and 340 g of isophorone diisocyanate was added at 70° C. over the course of 5 minutes, and the mixture was stirred at 120° C. until the theoretical NCO value was reached or the actual NCO value was slightly below the theoretical NCO value. The ready-produced prepolymer was dissolved with 4820 g of acetone and, in the process, cooled down to 50° C. and subsequently admixed with a solution of 27.3 g of ethylenediamine, 126.5 g of isophoronediamine, 67.0 g of diaminosulfonate and 1090 g of water metered in over 10 minutes. The mixture was subsequently stirred for 10 minutes. Then, a dispersion was formed by addition of 1180 g of water. This was followed by removal of the solvent by distillation under reduced pressure.

The white dispersion obtained had the following properties:

| | |
|---|---|
| Solids content: | 60% |
| Particle size (LKS): | 312 nm |
| Viscosity (viscometer, 23° C.): | 286 mPas |
| pH (23° C.): | 7.15 |

### Example 7

54 g of a polyurethane dispersion prepared according to example 2 were mixed with 1,37 g of Simulsol™ SL 26. In a suitable aerosol can, 6 g of a mixture of propellants consisting of i-butane/n-butane/propane were added. After spraying (wet film thickness about 1 cm) and drying (120° C., 10 min) a plain white, fine-porous foam was obtained.

### Example 8

54 g of a polyurethane dispersion prepared according to example 2 were mixed with 1,37 g of Simulsol™ SL 26. In a suitable aerosol can, 6 g of a of dimethylether were added. After spraying (wet film thickness about 1 cm) and drying (120° C., 10 min) a plain white, fine-porous foam was obtained

### Comparative Example 1

### Polyurethane Dispersion 7

Polyurethane dispersion, not representative of the present invention (does not contain sulfonate groups; hydrophilicization was through nonionic groups and carboxylate groups)

Example 1 is repeated except that the diaminosulfonate was replaced by an equimolar amount of a carboxylato-containing component:

206.8 g of Polyol 2, 78.7 g of Polyol 3, 159.5 g of Polyol 1 and 9.3 g of Polyol 4 were heated to 70° C. in a standard stirring apparatus. Then, a mixture of 49.7 g of hexamethylene diisocyanate and 65.6 g of isophorone diisocyanate was added at 70° C. over the course of 5 minutes, and the mixture was stirred at 120° C. until the theoretical NCO value was reached. The ready-produced prepolymer was dissolved with 1010 g of acetone and, during the process, cooled down to 50° C., and subsequently admixed with a solution of 5.3 g of ethylenediamine, 24.4 g of isophoronediamine, 11.9 g of KV 1386 (40% aqueous solution of the sodium salt of N-(2-aminoethyl)-β-alanine, BASF AG, Ludwigshafen, Germany) and 204 g of water metered in over 10 minutes. The mixture was subsequently stirred for 10 minutes. Then, a dispersion was formed by addition of 235 g of water. This was followed by removal of the solvent by distillation under reduced pressure. A total of 250 g of water had to be added because of the high viscosity.

The white dispersion obtained had the following properties:

| | |
|---|---|
| Solids content: | 47% |
| Particle size (LKS): | 918 nm |
| Viscosity (viscometer, 23° C.): | 162 mPas |
| pH (23° C.): | 7.22 |

Due to the comparatively high average particle size of >900 nm and contrary to the purely sulfonate-hydrophilicized dispersions, sedimentation of this dispersion was observed to begin within a few days. This makes further processing of this dispersion into wound contact materials difficult.

### Comparative Example 2

### Polyurethane Dispersion 8

Polyurethane dispersion, not representative of present invention (does not contain sulfonate groups; hydrophilicization was through nonionic groups and carboxylate groups)

Comparative Example 1 was repeated except that the amount of the carboxylato-containing hydrophilicizing component was increased by 50% (while keeping the degree of chain extension the same).

206.8 g of Polyol 2, 78.7 g of Polyol 3, 159.5 g of Polyol 1 and 9.3 g of Polyol 4 were heated to 70° C. in a standard stirring apparatus. Then, a mixture of 49.7 g of hexamethylene diisocyanate in 65.6 g of isophorone diisocyanate was added at 70° C. over the course of 5 minutes, and the mixture was stirred at 120° C. until the theoretical NCO value was reached. The ready-produced prepolymer was dissolved with 1010 g of acetone and, during the process, cooled down to 50C, and subsequently admixed with a solution of 5.3 g of ethylenediamine, 21.8 g of isophoronediamine, 17.9 g of KV 1386 (40% aqueous solution of the sodium salt of N-(2-aminoethyl)-β-alanine, BASF AG, Ludwigshafen, Germany) and 204 g of water metered in over 10 minutes. The mixture was subsequently stirred for 10 minutes. Then, a dispersion was formed by addition of 235 g of water. This was followed by removal of the solvent by distillation under reduced pressure.

The white dispersion obtained had the following properties:

| | |
|---|---|
| Solids content: | 52.2% |
| Particle size (LKS): | 255 nm |
| Viscosity (viscometer, 23° C.): | 176 mPas |
| pH (23° C.): | 8.31 |

Polyurethane dispersion 8 had a lower average particle size but a somewhat higher pH than Example 7. Further processing of polyurethane dispersion 8 to form wound contact materials was distinctly more difficult than with purely sulfonate-hydrophilicized dispersions.

### Examples 9 to 14

### Foams Produced from the Polyurethane Dispersions of Examples 1 to 6

The polyurethane dispersion of Examples 1-6 produced as described above in Examples 1-6 were mixed with the foam auxiliaries as set forth in the amounts indicated in Table 1 and frothed by means of a commercially available hand stirrer (stirrer made of bent wire) to a 1 liter foam volume. Thereafter, the polyurethane foams were drawn down on silicone-coated paper by means of a blade coater set to a gap height of 4 mm. Table 1 similarly recites the drying conditions for the polyurethane foams produced as indicated. Clean white polyurethane foams having good mechanical properties and fine pore structure were obtained without exception.

TABLE 1

| | Amount [g] | | | |
|---|---|---|---|---|
| | Polyurethane | | | |
| Foam | dispersion | Stokal ® | Stokal ® | |
| No. | (Example) | STA | SR | Curing |
| 9a | 235.0 (1) | 4.2 | 5.6 | 2 h/37° C. |
| 9b | 235.0 (1) | 4.2 | 5.6 | 2 h/37° C., 30 min/110° C. |
| 10 | 235.0 (2) | 4.2 | 5.6 | 2 h/37° C., 30 min/120° C. |
| 11a | 235.0 (3) | 4.2 | 5.6 | 2 h/37° C. |
| 11b | 235.0 (3) | 4.2 | 5.6 | 2 h/37° C., 30 min/120° C. |
| 12a | 235.0 (4) | 4.2 | 5.6 | 2 h/37° C. |
| 12b | 235.0 (4) | 4.2 | 5.6 | 2 h/37° C., 30 min/120° C. |
| 13a | 235.0 (5) | 4.2 | 5.6 | 2 h/37° C. |
| 13b | 235.0 (5) | 4.2 | 5.6 | 2 h/37° C., 30 min/120° C. |
| 14 | 235.0 (6) | 4.2 | 5.6 | 2 h/37° C., 30 min/120° C. |

As is evident from Table 2, all the polyurethane foams exhibited a very rapid imbibition of water, a high absorption of physiological saline (i.e. “free swell absorption”), a very high moisture vapor transmission rate (i.e. MVTR) and also good mechanical strength, in particular after moist storage.

TABLE 2

| | | Free | |
|---|---|---|---|
| Foam | Imbibition | absorbency²⁾ | MVTR³⁾ |
| No. | rate¹⁾ [s] | [g/100 cm²] | [g/m² * 24 h] |
| 9a | not | 23.1 | 4300 |
| | determined | | |
| 9b | not | 19.2 | 5000 |
| | determined | | |
| 10 | 3 | 28.4 | 4700 |
| 11a | 4 | 20.6 | 4300 |
| 11b | 14 | 18.3 | 4300 |
| 12a | 4 | 24.7 | 4800 |
| 12b | 7 | 26.7 | 4500 |
| 13a | 5 | 25.5 | 4800 |
| 13b | 7 | 23.1 | 4100 |
| 14 | 4 | 21.3 | not |
| | | | determined |

¹⁾time for complete penetration of a drop (of distilled water) into the foam;
²⁾absorption of physiological saline determined according to DIN EN 13726-1 Part 3.2 (5 instead of 9 test samples);
³⁾moisture vapour transmission rate determined according to DIN EN 13726-2 Part 3.2

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for producing polyurethane wound dressing foams comprising frothing and physically drying a polyurethane foam forming composition without chemical crosslinking, in which the polyurethane foam forming composition comprises (I) at least one anionically hydrophilicized, aqueous polyurethane dispersion.

2. The process of claim 1, in which (I) said polyurethane dispersion is anionically hydrophilicized only by sulfonate groups.

3. The process of claim 2, in which the sulfonate groups have alkali metal cations as counter-ions.

4. The process of claim 1, in which (I) said polyurethane dispersion comprises from 0.1 to 15 milliequivalents of anionic or potentially anionic groups per 100 g of solid polyurethane.

5. The process of claim 1, wherein (I) said polyurethane dispersion has a solids contents in the range from 55% to 65% by weight, based on 100% by weight of the polyurethane present in the dispersion.

6. The process of claim 1, wherein (I) said polyurethane dispersion comprises the reaction product of:
A) at least one isocyanate-functional prepolymers which comprises the reaction product of:
A1) at least one organic polyisocyanate, with
A2) at least one polymeric polyol having a number-average molecular weight in the range from 400 to 8000 g/mol and an OH functionality in the range from 1.5 to 6, and
A3) optionally, one or more hydroxyl-functional compounds having molecular weights in the range from 62 to 399 g/mol, and
A4) optionally, one or more isocyanate-reactive, anionic or potentially anionic and optionally nonionic hydrophilicizing agents; with
B) one or more compounds selected from the group consisting of:
B1) optionally, one or more amino-functional compounds having molecular weights in the range from 32 to 400 g/mol, and
B2) one or more amino-functional, anionic or potentially anionic hydrophilicizing agents;
in which the free NCO groups of A) are reacted completely or partially by chain extension, and in which A) the prepolymers are dispersed in water before, during or after the reaction with component B).

7. The process of claim 1, in which the polyurethane foam forming compositions that are to be frothed additionally comprise (II) one or more auxiliary agents and/or additive materials.

8. The process of claim 7, in which (II) said auxiliary agents and/or additives materials comprise foam formers and stabilizers which are selected from the group consisting of fatty acid amides, sulfosuccinamides, hydrocarbyl sulfonates or sulfates alkylpolyglycosides and/or fatty acid salts.

9. The process of claim 8, in which said foam formers and stabilizers comprise mixtures of sulfosuccinamides and ammonium stearates, with the mixture containing from 50% to 70% by weight of sulfosuccinamides.

10. Polyurethane wound dressing foams produced by the process of claim 1.

11. The polyurethane wound dressing foams of claim 10, in which the polyurethane foam is characterized by a microporous, open-cell structure and a density of below 0.4 g/cm³ in the dried state.

12. The polyurethane wound dressing foams of claim 11, wherein the polyurethane foam has a physiological saline absorbency of 100 to 1500% (mass of liquid taken up, based on the mass of dry foam) and a water vapor transmission rate in the range from 2000 to 8000 g/24 h*m².

13. The wound contact materials of claim 10, which additionally comprise an active component.
